(19) United States
(12) Patent Application Publication
(10) Pub. No.: US 2018/0186695 A1
(43) Pub. Date: Jul. 5, 2018

(54) METHOD FOR BINDING OF CARBON DIOXIDE

(71) Applicant: HeidelbergCement AG, Heidelberg (DE)

(72) Inventors: Anca ITUL, Heidelberg (DE); Mohsen BEN HAHA, Heidelberg (DE); Nicholas SPENCER, Malsch (DE)

(73) Assignee: HeidelbergCement AG, Heidelberg (DE)

(21) Appl. No.: 15/741,648

(22) PCT Filed: Jun. 25, 2016
(86) PCT No.: PCT/EP2016/001108

§ 371 Date: Jan. 3, 2018

(30) Foreign Application Priority Data
Jul. 6, 2015 (EP) 15002019.6

(51) Int. Cl. C04B 28/18; C04B 40/02

(52) U.S. Cl. CPC C04B 28/18; C04B 2111/00603; C04B 40/0231

(57) ABSTRACT

The invention relates to a method for binding of carbon dioxide, comprising: providing a starting material which comprises sources for CaO and SiO₂ and optionally also Al, Fe and/or Mg, hydrothermally treating the starting material in an autoclave at 50 to 300° C., tempering at 350 to 600° C., and hardening the resulting material with carbon dioxide. The invention further relates to building elements which are obtained by hardening a material according to the method.

The present invention relates to a method by which carbon dioxide can be bound, and building elements made of a material which is obtainable by the method.

The emission of carbon dioxide has been steadily increasing over the last few decades, and is held by many to be responsible for climate change, above all rising average temperatures. Consequently, for some time there have been efforts to stop the increase in the level of carbon dioxide in the atmosphere, and ideally even lower the level.

One proposal is to convert the carbon dioxide produced by power stations and other facilities into useful products, see for example U.S. Pat. No. 8,114,367 B2, US 2006/0185560 A1, U.S. Pat. No. 8,367,025 B2, US 2013/0112115 A1 and EP 2 511 003 A1. The replacement of cement with a material that absorbs carbon dioxide is therefore of particular interest, as the production of cement still releases a great deal of carbon dioxide, despite diverse efforts and successes.

U.S. Pat. No. 8,114,367 B2, however, lacks a concrete description of suitable materials and their production. Later applications by the same inventor describe wollastonite, CaSiO₄ or short CS as a material which hardens while binding carbon dioxide. Its manufacture requires firing of a suitable starting material, still at 1200° C., which limits the saving of carbon dioxide.

Alternative belite cements can be obtained, for example, by hydrothermal treatment in an autoclave at from 100 to 300° C. and subsequent reaction milling (EP 2 243 754 A1) or heat treatment at under 500° C. (EP 2 676 943 A1). However, belite cements harden hydraulically, and so do not bind any carbon dioxide during hardening.

The object of finding methods of binding carbon dioxide thus still exists.

Surprisingly, it has now been found that a material produced by hydrothermal treatment and tempering can harden by binding of carbon dioxide.

The above object is therefore solved by a method in which a starting material which comprises sources for CaO and SiO₂ is subjected to hydrothermal treatment in an autoclave at from 50 to 300° C. and the obtained material hardens with carbon dioxide after tempering at from 350 to 600° C. The invention also relates to building elements which are obtained by hardening a material with carbon dioxide, wherein the material was obtained by hydrothermal treatment of a starting material, which comprises sources for CaO and SiO₂, in an autoclave at 100 to 300° C. and tempering at 350 to 600° C.

The following abbreviations that are common in the cement industry are used: H—H₂O, C—CaO, A—Al₂O₃, F—Fe₂O₃, M—MgO, S—SiO₂ and $—SO₃. In order to simplify the further description, generally compounds are stated in their pure form, without explicit stating solid solution series/substitution by foreign ions etc., as are common in technical and industrial materials. As is understood by every person skilled in the art, the composition of the phases nominally stated in this invention can vary depending on the chemism of the raw meal and the kind of production as a result of the substitution with various foreign ions, wherein such compounds also fall within the scope of protection of the present invention, and shall be comprised by stating the pure phases/compounds.

The method according to the invention comprises the hydrothermal treatment of a starting material of one or more raw materials which provide sufficient amounts of CaO and SiO₂. On the one hand, pure or substantially pure raw materials such as calcium hydroxide or oxide and quartz powder or microsilica are suitable. On the other hand, a large number of natural but also industrial materials such as, but not limited to, bauxite, clay/claystone, calcined clays (e.g. metakaolin), basalts, peridotites, dunites, ignimbrites, ashes/slags/ground granulated blast furnace slags of high and low quality (with regard to mineralogy/glass content, reactivity, etc.), various stockpile materials, red and brown muds, natural sulphate carriers, desulphurisation muds, phosphogypsum, flue gas gypsum, titanogypsum, fluorogypsum, etc., can be used as a starting material in a suitable combination. Substances/groups of substances which are not mentioned are also included in the scope of protection, which meet the minimum chemical requirements as potential raw materials. Secondary raw materials, i.e. side products and waste products, are preferably used as raw materials.

Raw materials which contain both SiO₂ and CaO are particularly preferred, such that the desired molar ratio Ca/Si is already present. If the desired Ca/Si ratio is not present, prior to further treatment the raw materials must be adjusted with respect to chemical composition to a suitable Ca:Si molar ratio in the starting material, generally from 1.5 to 2.5, by the addition of further reaction partners such as Ca- or Si-containing solids. Portlandite Ca(OH)₂ or calcined lime is, for example, suitable for this purpose. As a rule, the raw materials or the starting material are optimised by means of mechanical or thermal treatment with respect to particle size and particle size distribution, wherein the thermal treatment can also lead to an optimisation of the chemical composition.

In addition to sources for CaO and SiO₂, a large proportion of the raw materials also introduce other elements such as aluminium, iron, magnesium and others into the starting material mixture. These additional elements are incorporated into the phases as foreign ions or form their own phases. If present, a molar ratio (Ca+Mg)/(Si+Al+Fe) of 1 to 3.5, a molar ratio Ca:Mg of 0.1 to 100 and a molar ratio (Al+Fe)/Si of 100 to 0.1 is preferred. The molar ratio of the sum of calcium and magnesium to the sum of silicon, aluminium and iron is preferably from 1.5 to 2.5, particularly preferred about 2. The ratio of calcium to magnesium is preferably from 0.2 to 20, particularly preferred from 0.5 to 5. The ratio of the sum of aluminium and iron to silicon is preferred from 100 to 10 for a high aluminium content, from 1 to 20 for an average aluminium content and from 0.01 to 2 for a low aluminium content. The calculation also takes into account the proportions which are inert.

In a preferred embodiment, fine grain material is selected as the starting material, the maximum particle size of which is preferably at most 0.1 mm. In particular, the finer grain fractions from the reprocessing of cement-containing binding agents in building materials such as old concrete and cement are used for this. A finer starting material is advantageous both with regard to the reaction rate and with regard to the expenditure for the grinding of the finished material for the reaction with carbon dioxide. With an appropriately fine starting material, grinding can be dispensed with.

During the mixing of the raw materials or in one of the subsequent process steps, additional elements or oxides are preferably added in an amount of from 0.1 to 30 by weight. Sodium, potassium, boron, sulphur, phosphorus or combinations thereof are preferred as these additional elements/oxides, which are also referred to collectively as foreign oxides. Alkali and/or alkaline earth metal salts and/or hydroxides are suitable for this purpose, for example CaSO₄.H₂O, CaSO₄.1/2H₂O, CaSO₄, CaHPO₂, 2H₂O, Ca₃P₂O₈, NaOH, KOH, MgSO₄, Na₂Al₂O₄, Na₃PO₄, Na₂[B₄O₅(OH)₄].8H₂O, etc. In a preferred embodiment, the starting material mixture has a molar ratio P/Si of about 0.05 and/or S/Si of about 0.05 and/or K/Ca of about 0.05.

The raw material mixture, which has optionally been pre-treated as described if necessary, can, if appropriate, be admixed, i.e. seeded, with seed crystals which contain, for example, calcium silicate hydrates, Portland clinker, ground granulated blast furnace slag, magnesium silicates, calcium sulphate aluminate (belite) cement, water glass, glass powder, etc. The reaction can be accelerated herein by seeding with 0.01 to 30% by weight of various calcium silicate and calcium silicate hydrate containing compounds, in particular with α-2CaO.SiO₂.H₂O, afwillite, calciochondrodite, β-Ca₂SiO₄ and other compounds.

The produced mixture of the raw materials, which is optionally seeded as described above, is then subjected to a hydrothermal treatment in an autoclave at a temperature of from 100 to 300° C., preferably from 150 to 250° C. Preferably, a water/solid ratio of from 0.1 to 100, preferably from 2 to 20, and residence times of from 0.1 to 24 hours, preferably from 1 to 16 hours, are selected herein. The pressure during the hydrothermal treatment depends mainly on the temperature and usually corresponds to the steam pressure of water at the selected temperature. At 150° C. approx. 4.75 bar, at 200° C. approx. 15 bar, at 250° C. approx. 40 bar and at 300° C. approx. 85.8 bar are to be expected.

A preferred source of heat for the hydrothermal treatment is microwaves, in which case the autoclave is combined with a microwave generator.

The obtained material comprises, in particular, calcium silicate hydrates, and, depending on the raw materials, also calcium aluminate hydrate or calcium aluminium silicate hydrate or magnesium silicate hydrate or calcium magnesium silicate hydrate or magnesium (aluminium, iron) silicate hydrate or magnesium (calcium, aluminium, iron) silicate hydrate and optionally further compounds, and is already suitable for reaction with carbon dioxide. The material contains at least one, usually several, of said calcium and/or magnesium silicate or aluminate hydrates, typically:
0.01 to 100% by weight of α-C₂SH, various C—S—H forms, including dellaite and partially carbonated C—S—H phases, and amorphous and low crystalline phases thereof
0 to 80% by weight of katoite, Si-katoite, Fe-katoite, mono- and hemicarbonates as well as amorphous and low crystalline phases
0 to 80% by weight of magnesium (calcium, aluminium, iron) silicates, silicate hydrates as well as amorphous and low crystalline phases thereof
0 to 80% by weight of aluminium and/or iron silicates and silicate hydrates, as well as amorphous and low crystalline phases thereof
trace and secondary constituents such as aluminium/iron oxides and hydroxides, C₂AS, CH, MgCO₃, Mg(OH)₂, quartz and calcite.

Terms such as magnesium (aluminium, iron) silicate hydrate and magnesium (calcium, aluminium, iron) silicate mean that it is a magnesium silicate hydrate or magnesium silicate, in which magnesium can be partially replaced by aluminium and/or iron, or calcium, aluminium and/or iron, but does not have to be. The elements indicated in brackets optionally replace the preceding element, individually or together.

The product of the hydrothermal treatment is subsequently tempered. The tempering is carried out at a temperature of 350° C. to 600° C. The heating rate here is from 10 to 6000° C./min, preferably from 20-100° C./min and particularly preferred about 40° C./min, and the residence time is from 0.01 to 600 minutes, preferably from 1 to 120 minutes, and particularly preferred from 5 to 60 minutes. To reduce the proportion of slow reacting γ-C₂S, an additional holding time during the heating at from 400 to 440° C. from 1 to 120 minutes, preferably from 10 to 60 minutes, has proven of value. No reaction grinding takes place.

It is possible to grind the product obtained by the hydrothermal treatment before tempering. The grinding process can be carried out on both the wet and on the dried intermediate product. Surprisingly, it has been found that grinding the intermediate product leads to significantly more reactive end products. However, no reactive grinding takes place, i.e. the grinding energy supplied is limited so that substantially no chemical or mineralogical transformations are triggered. The aim of the grinding is a deagglomeration and an improvement in the particle size range.

In a preferred embodiment, the expelled water is removed during the tempering, preferably by a gas stream. For this purpose an air stream, but also an inert gas stream or a vacuum, as well as a large surface area/volume ratio, are suitable.

After the tempering, a product is obtained which typically comprises at least one calcium silicate and at least one X-ray amorphous phase, as well as calcium aluminate, calcium aluminium silicate, magnesium (calcium, aluminium, iron) silicate and/or calcium magnesium silicate depending on the raw materials. As a rule the product contains the following components:
1-100% by weight of C₂S polymorphs, as crystalline, low crystalline or amorphous phases
0-30% by weight of hydrates from the hydrothermal treatment,
0-95% by weight of reactive calcium aluminates, preferably in the form of crystalline C₁₂A₇, or of low crystalline or amorphous aluminate phases
0-80% by weight of magnesium (calcium, aluminium, iron) silicates, as crystalline, low crystalline or amorphous phases which can contain foreign ions such as Fe, Al, Ca
0-80% by weight of calcium aluminate silicates, as crystalline, low crystalline or amorphous phases
1-80% by weight of calcium magnesium aluminate silicates, as crystalline, low crystalline or amorphous phases and
up to 30% by weight of trace and secondary constituents, in particular C₅A₃, CA, calcium oxide, γ-aluminium oxide and other aluminium oxides, quartz and/or limestone, CaO, calcium sulphate, MgCO₃, Mg(OH)₂, Fe₃O₄, iron silicates such as Fe₂SiO₄, amorphous iron-containing phases,
   wherein all proportions of the product add up to 100% and the sum of calcium silicates, calcium aluminates, calcium aluminium silicates, magnesium silicates and calcium magnesium silicates is at least 30% by weight, preferably at least 50% by weight, most preferably at least 70% by weight.

According to the invention, the product obtained after hydrothermal treatment and tempering is suitable as a binder, which hardens by reaction with carbon dioxide and thus constitutes a material for the absorption of carbon dioxide. When reacting with carbon dioxide, the material develops strength similar to that of cement when it reacts with water, and can therefore be used instead of cement.

If necessary the material is ground to a desired fineness, as is known per se from cement production. The same devices and grinding agents, such as, for example, for Portland cement, are useful. The fineness is typically from 2000 to 10,000 cm²/g, in particular from 3000 to 5000 cm²/g, measured according to Blaine.

Similarly to cement, aggregates are usually also added. Additives and/or admixtures as well as possibly supplementary cementitious materials such as pozzolans and latent hydraulic materials can also be added.

Unlike cement, the material does not require adding water. However, water is preferably added in order to adjust the consistency, but other liquids such as alcohols would be equally possible.

The material is then poured into moulds for the production of building elements or processed as mortar or cast-in-place concrete.

The building elements according to the invention are a particularly preferred applications of the material, since the production can be arranged locally in a simple manner near plants which emit carbon dioxide. Thus, on the one hand, a high concentration of carbon dioxide can be easily created for quick hardening. On the other hand, ways to transport carbon dioxide that has been filtered from the exhaust gases of such plants are dispensed with. However, it is of course also possible to convert carbon dioxide which has been reversibly bound somewhere to an adsorbent by release from the adsorbent at the site of use of the material obtained according to the invention with the material.

A particular advantage is that hardening occurs much more quickly than with Portland cement, usually within a day instead of within 28 days as with Portland cement.

After the hardening, mainly calcite, silica gel, carbonated forms of calcium aluminate hydrate or calcium aluminate silicate hydrate or magnesium silicate hydrate or calcium magnesium silicate hydrate or magnesium (aluminium, iron) silicate hydrate or magnesium (calcium, aluminium, iron) silicate hydrate or carbonated forms of calcium silicate, calcium aluminate, calcium aluminium silicate, magnesium (calcium, aluminium, iron) silicate or calcium magnesium silicate are present.

Prefabricated parts for construction such as walls, ceilings, plates, posts, paving stones, sleepers, roof tiles, etc. are particularly preferably produced by the method according to the invention.

The invention will be explained using the following examples, without, however, being limited to the specifically described embodiments. Unless stated otherwise, or where the context absolutely requires otherwise, percentages are based on weight, in case of doubt to the total weight of the mixture.

The invention also relates to all combinations of preferred embodiments, provided that these do not mutually exclude each other. The terms “about” or “approx.” in conjunction with a numerical indication mean inclusive of at least 10% higher or lower values, or 5% higher or lower values and in any case 1% higher or lower values.

### EXAMPLE 1

A starting material mixture was prepared from calcium hydroxide and colloidal silica with a molar ratio Ca:Si of 2 with the addition of water in a water/solids ratio of 2. The mixture was treated for 6 hours in an autoclave at 200° C. The product was tempered at 460° C. for 1 hour. The product contained 30.7% C₂S (various polymorphs), 5.1% CaCO₃, 22.2% dellaite, 2.6% afwillite and 39.4% X-ray amorphous phase.

Since the raw materials were already very fine, no grinding was necessary. To determine the potential of the material for reaction with carbon dioxide, 5.5 g of product were placed in a CO₂-containing environment for 72 hours. For this purpose, 0.94 g of NaHCO₃ was dissolved in 10 g of water and the product was immersed in the solution. The concentration of CO₂ was 4.9%.

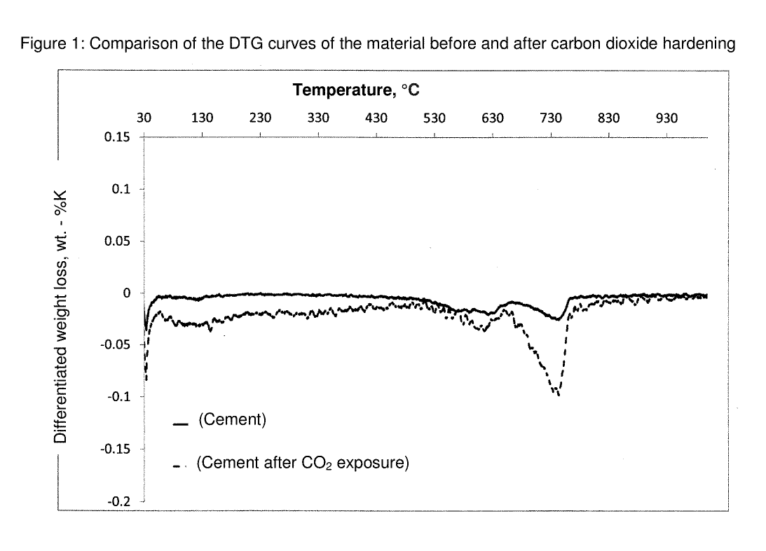

X-ray spectra of the material were recorded before and after the carbon dioxide hardening and a thermogravimetric analysis (DTG) was carried out. The measured values in Table 1 show that the decrease in the C₂S content is associated with an increase in the formation of calcite. An increase in the content of the amorphous phase was also found. The DTG curves in FIG. 1 demonstrate the conversions during the carbon dioxide hardening.

TABLE 1
phase composition according to X-ray spectrum

| Phase | Material | Material after CO₂ hardening |
|---|---|---|
| CaCO₃ | 5.1% | 17.9% |
| C₂S | 30.7% | 9.3% |
| Dellaite | 22.2% | 16% |
| Afwillite | 2.6% | — |
| Tobermorite | — | 8.7% |
| amorphous | 39.4% | 48.1% |

1. A method for binding of carbon dioxide, comprising:
providing a starting material which contains sources of CaO and SiO₂,
hydrothermally treating the starting material in an autoclave at 50 to 300° C.,
tempering the material obtained by hydrothermal treatment at 350 to 600° C.,
adding water or other fluids for adjusting the consistency,
pouring in molds for the production of building elements or processing as mortar or cast-in-place concrete, and
hardening the material obtained by hydrothermal treatment and tempering with carbon dioxide.

2. The method according to claim 1, wherein the starting material is selected from the group consisting of calcium hydroxide or oxide, quartz powder, microsilica, bauxite, clay/claystone, calcined clays, basalts, peridotites, dunites, ignimbrites, carbonatites, ashes/slags/ground granulated blast furnace slags, various stockpile materials, red and brown muds, natural sulphate carriers, desulphurisation muds, phosphogypsum, flue gas gypsum, titanogypsum and fluorogypsum.

3. The method according to claim 1, wherein a molar Ca:Si ratio in the starting material is set to be from 1.5 to 2.5.

4. The method according to claim 1, wherein the starting material comprises sources of Mg, wherein a molar ratio of Ca:Mg is set to be from 0.1 to 100.

5. The method according to claim 1, wherein the starting material comprises sources for Al and/or Fe, wherein a molar ratio (Al+Fe)/Si is set to be from 100 to 0.1.

6. The method according to claim 4, wherein a molar (Ca+Mg)/(Si+Al+Fe) ratio is set to be from 1 to 3.5.

7. The method according to claim 1, wherein that starting material mixture is seeded with 0.01 to 30% by weight of seed crystals, which contain at least one material selected from the group consisting of calcium silicate hydrate, Portland clinker, ground granulated blast furnace slag, magnesium silicate, calcium sulfoaluminate (belite) cement, water glass, and glass powder.

8. The method according to claim 1, wherein the hydrothermal treatment is carried out at a temperature of from 100 to 300° C.

9. The method according to claim 1, wherein the hydrothermal treatment is carried out at a water/solid ratio of from 0.1 to 100.

10. The method according to claim 1, wherein residence times of from 0.1 to 24 hours are set for the hydrothermal treatment.

11. The method according to claim 1, wherein, during the heat treatment, an additional holding time during heating of from 1 to 120 minutes at 400 to 440° C. is provided.

12. The method according to claim 11, wherein the heating rate during heat treatment is from 10 to 6000° C./min.

13. The method according to claim 11, wherein the residence time during the heat treatment is from 0.01 to 600 minutes.

14. The method according to claim 1, wherein the material is milled to a fineness of 2000 to 10,000 cm²/g, measured according to Blaine.

15. The method according to claim 1, wherein the material is mixed with a fluid, and shaped into a paste prior to hardening.

16. The method according to claim 1, wherein the material is mixed with rock particles prior to hardening.

17. The method according to claim 1, wherein the material is mixed with additives and/or addition agents, as well as clinker substitute material, prior to hardening.

18. A method for the production of a building element by hardening a material with carbon dioxide in the method according to claim 1.

19. The method according to claim 18, wherein the building element is a prefabricated part for construction.
